(19) United States
(12) Patent Application Publication
(10) Pub. No.: US 2014/0258073 A1
(43) Pub. Date: Sep. 11, 2014

(54) CURRENCY EXCHANGE METHOD

(71) Applicant: FreemarketFX Limited, London (GB)

(72) Inventors: Alex Hunn, East Sussex (GB); Fraser Davidson, Sutton (GB); Rory Bernard, Teilhet (FR)

(73) Assignee: FreemarketFX Limited, London (GB)

(21) Appl. No.: 14/199,225

(22) Filed: Mar. 6, 2014

(30) Foreign Application Priority Data
Mar. 7, 2013 (GB) 1304311.2

(51) Int. Cl. G06Q 40/04

(52) U.S. Cl. CPC G06Q 40/04
USPC 705/37

(57) ABSTRACT

A plurality of customers are connected via their work stations 1 and the internet to a provider's server 2. This is connected in turn to provider's work station(s) 3, the provider's deposit taking bank 4 and the provider's foreign exchange providing bank 5. Additional connections are from the customers to their banks 6. The latter are connected to the deposit taking bank. Users make deposits during an order period in either of two currencies with a view to being provided with an equivalent amount in the other currency. At the end of the order period, the deposits are amalgamated and applied to the orders in the other currencies. A surplus of one currency is converted to the other to satisfy the orders as far as possible.

The present invention relates to currency exchange method.

Normally foreign currency is transacted in a conventional manner, either via banks or intermediaries (brokers). Traditionally there are substantial overheads involved in such transactions, with the result that there is a substantial difference between the selling and buying rates (i.e. the spread) for currencies provided to clients.

Accordingly there is an in-built cost in foreign currency transactions and, more particularly, cost to customers in acquiring foreign currency for both their business and/or personal activities.

Many market places facilitate the matching of client buy and sell orders to achieve optimum efficiency via exchange methodology. At present acquiring foreign currency has no well defined market and is in reality a ‘purchase’ rather than an exchange, due to there being no established exchange principles in operation. (i.e. you buy your destination currency as there is no current mechanism for one to exchange it).

This is because the direct matching of individual exchange customer's requirements is difficult. Whilst there are relatively few currencies, customers have widely differing requirements in terms of amounts, regularity and timing of currency. Further the rate of exchange itself is determined by both macro and micro economic factors beyond the client's control.

The object of the present invention is to provide an improved method of currency exchange.

According to the invention there is provided a method of currency exchange to be operated by a currency provider, consisting in the steps of:
receiving over an order period from one or more first customers:
   deposits in one, first currency (‘the first currency deposits’) and
   instructions in respect of the use of at least part of their first currency deposits in the form of:
      sell instructions for the sale of a specified amount of first currency in exchange for second currency substantially equal in value or
      buy instructions for the purchase of a specified amount of second currency
   (‘the first currency sell orders and the second currency buy orders’);
receiving over the order period from one or more second customers:
   deposits in the other, second currency (‘the second currency deposits’) and
   instructions in respect of the use of at least part of their second currency deposits in the form of:
      sell instructions for the sale of a specified amount of second currency in exchange for first currency substantially equal in value or
      buy instructions for the purchase of a specified amount of first currency
   (‘the second currency sell orders and the first currency buy orders’); and
performing the following steps on expiry of the order period:
   summing the first currency orders;
   summing the second currency orders;
      comparing the sums of the orders and computing a surplus of one currency and a shortfall of the other;
   acquiring from a third party a balancing amount of whichever currency is in shortfall from the surplus of the other currency;
   distributing the substantially equal value parts of second currency deposits and the purchased shortfall if any to the first customers in accordance with their second currency orders;
   distributing the substantially equal value parts of first currency deposits and the purchased shortfall if any to the second customers in accordance with their first currency orders; and
retaining a provider's charge from the deposits.

Where the provider is a bank, the deposits can be made into accounts with it. Where the provider is offering foreign exchange via the method without being a deposit taking bank, the deposits can be made into client accounts in the name of the provider with a third party bank. It is expected that the client accounts will be escrow accounts whereby the provider does not have beneficial ownership of the deposited moneys, but has the power to deal with the moneys in the manner for which they were deposited, namely conversion to a different currency.

Where two currencies are concerned and deposits are converted from one to the other and vice versa, two escrow accounts only need be established by the provider and all deposits in the first currency, whether for buy or sell orders, are credited to the first currency escrow account. Similarly all second currency deposits are credited to the second currency escrow account. Nevertheless, for the purposes of the method, each customer's balance in the respective escrow accounts is separately accounted for as the respective customer's sub-balance with the overall balance in the respective account.

It is envisaged that the method could be operated by individual escrow bank accounts for each customer. However, in such case, the distribution steps would be prefaced by steps of transfer between escrow accounts of the individual customers from original currencies to converted currencies. This would involve multiple bank transfers, such as to add to the cost of the exchange and detract from its competitiveness. For this reason two escrow accounts only with separate accounting for each customer are preferred.

Normally the timing of the order period will be published and fixed, but it is anticipated that it may be prematurely terminated, in unusual circumstances, such as a receipt of a disproportionate order such as to disrupt the likelihood of close matching with a comparatively small balancing amount of orders over the period. Such order may be disallowed and the rest of the orders exchanged without it.

Normally no order will be included in the steps on expiry of the order period unless a corresponding deposit has been made in cleared funds.

It is anticipated that the deposits may be in excess of the value of currency to be sold in associated sell orders or in excess of value of currency to be used in associated buy orders. In such circumstances only the part of the deposit substantially equal to that required for the order in question will be taken account of in the steps on expiry of the order period.

Usually the balances on the two escrow accounts at the end of the order period will reflect which currency is in surplus. However, this may not be so where customers have deposited in excess of their current orders, in anticipation, for instance, of future orders. Precise summing in accordance with the accounting of the customers' orders will indicate the precise surplus of one currency and the precise deficit of the other currency and therefore the balancing amount required for the exchange.

Whilst the acquisition of the balancing amount can be via a buy order placed on the third party in respect of the currency in shortfall, it is preferably via a sell order in the currency in surplus. In either case the amount of currency required for balancing is withdrawn from the escrow account for the currency in surplus and the converted balancing amount is deposited in the account in deficit.

With the acquired balancing amount deposited, the distribution from the two escrow accounts can be commenced to the bank accounts of the customers nominated with their instructions.

Whilst it is expected that sell orders will be accompanied by a deposit in the respective currency of an actual amount the currency to be sold for whatever amount of the other currency can be exchanged; where a buy order is placed, the respective deposit has to be sufficient to allow for the cost of the exchange, taking account of the provider's charge and the potential range of movement in the exchange rate.

To enable customers to effect sufficient deposits to cover buy orders, the method can include publication of provisional exchange rates for the first currency to the second currency and for the second currency to the first currency from the beginning of the order period and an indication of a marginal amount of additional deposit needed to cover the cost of the exchange.

Whilst it is possible for the provider to charge on fixed fee per transaction; preferably the provider's charge is a commission pro rata based on the respective value of the respective order.

Where rates of exchange are stable, the provisional rate of exchange can be used to convert the deposits in the original currencies to values to be used in calculating the surplus and shortfall, with the balancing amount being converted at the prevailing rate offered by the third party.

However in times of uncertainty, exchange rates are volatile and the original rate can be replaced by the prevailing rate at the end of the order period. In either case, the prevailing rate can be the mid-point price, that is the geometric mean of the buy and sell rate, preferably of the third party.

Preferably the matching and balance acquisition are performed as follows:
1. the mid-point prices for conversion of the first currency to the second and vice versa, which rates are the reciprocals of each other, are used to calculate:
   1.1 the sum A of the values of the first currency sell orders into second currency and the sum a of the values of the second currency to be exchanged therefrom,
   1.2 the sum B of the values of the second currency sell orders into first currency and the sum b of the values of the first currency to be exchanged therefrom;
   1.3 the sum C of the values of the first currency required to meet the secondary currency buy orders for specified amounts of the second currency and the sum c of the values of the second currency to be exchanged therefrom,
   1.4 the sum D of the values of the second currency required to meet the first currency buy orders for specified amounts of the first currency and the sum d of the values of the first currency to be exchanged therefrom;
   (The sums A & B are known from the sell orders; the sums a & b are derived therefrom via the mid-point price; the sums c & d are known from the buy orders; the sums C & D are derived therefrom via the mid-point price; the sums A & C are deposited in the first currency and the sums B & D are deposited in the second currency; the sums a & c are exchanged second currency; and the sums b & d are exchanged first currency);
2. the surpluses/shortfalls are calculated as (A+C)−(b+d) in first currency and (B+D)−(a+c) in second currency and are equivalent to each other, one being a +ve surplus in one currency, the other being a −ve shortfall in the other currency;
3. the surplus of the currency in surplus is sold to allow the exchange to proceed.

A refinement is possible to take account of changes in exchange rate between the point at which the mid-point price was obtained from the third party and the actual occurrence of the sale of the balancing amount surplus and of the acquisition being at the third party's sell rate which differs from the mid-point price:
An extra small buffer is added to the sale of currency in surplus by a sell order (or non-preferred purchase of currency in deficit by a buy order) whereby an adequate amount of the currency in deficit is assured and any residual difference is distributed between the customers.

The residual difference is apportioned both to customers' sell orders in respective currencies and to customers' remaining balance of buy order deposits in proportion to the values of their orders. These values are calculated in the currency of the acquired balancing amount by applying the mid-point price to the other currency values. Similarly the apportionment is in the currency of the acquired balancing amount and the apportionment to the other currency is calculate in the same manner. Where the residual difference is to be apportioned in the other currency from that in which it was acquired, the provider retains that part of the residual difference in its currency as a credit to a provider's sub-balance in the relevant currency escrow account and contributes its equivalent in the other currency by debiting a provider's sub-balance in the other currency escrow account.

Normally, in the case of sell orders, the distributed first and second currency deposits will be nett amounts, from which costs of the exchange, in particular the provider's charge, have been debited. In the case of buy orders, the distributed deposits will be ordered amounts of currency, with the cost of the exchange being debited from the deposit. The balance of the deposit is available to be returned to the customer, unless he wishes to leave it on deposit towards a future order.

To guard against the currency provider being unable to satisfy the orders, not only will orders be executed only where sufficient funds have been deposited, the customers' funds cannot be withdrawn from the escrow accounts, in particular not after the end of the order period.

It is envisaged that the customers' orders and deposits can be received in respect of one or more additional currency and the steps on expiry of the order period will be performed for each additional currency in like manner to those for the first and second currency.

To help understand the general concept of the invention, a specific operation thereof will now be described by way of example, with reference to the drawings, in which:

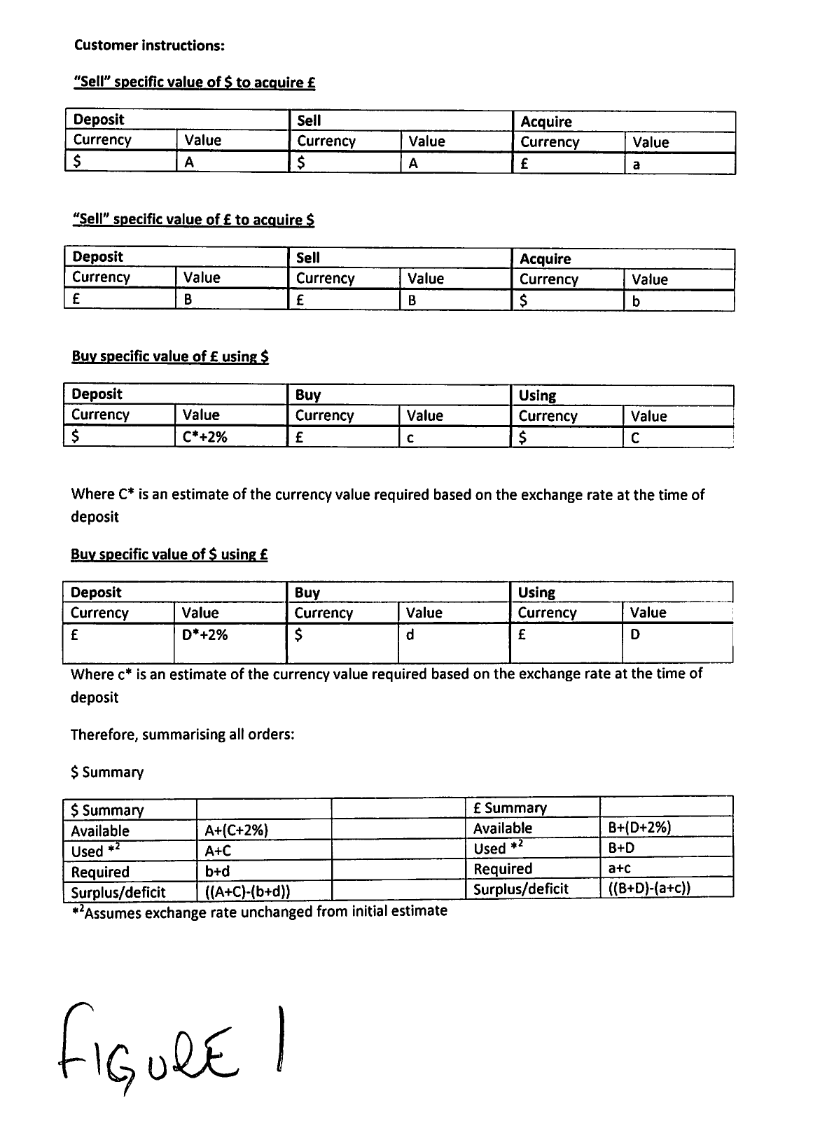

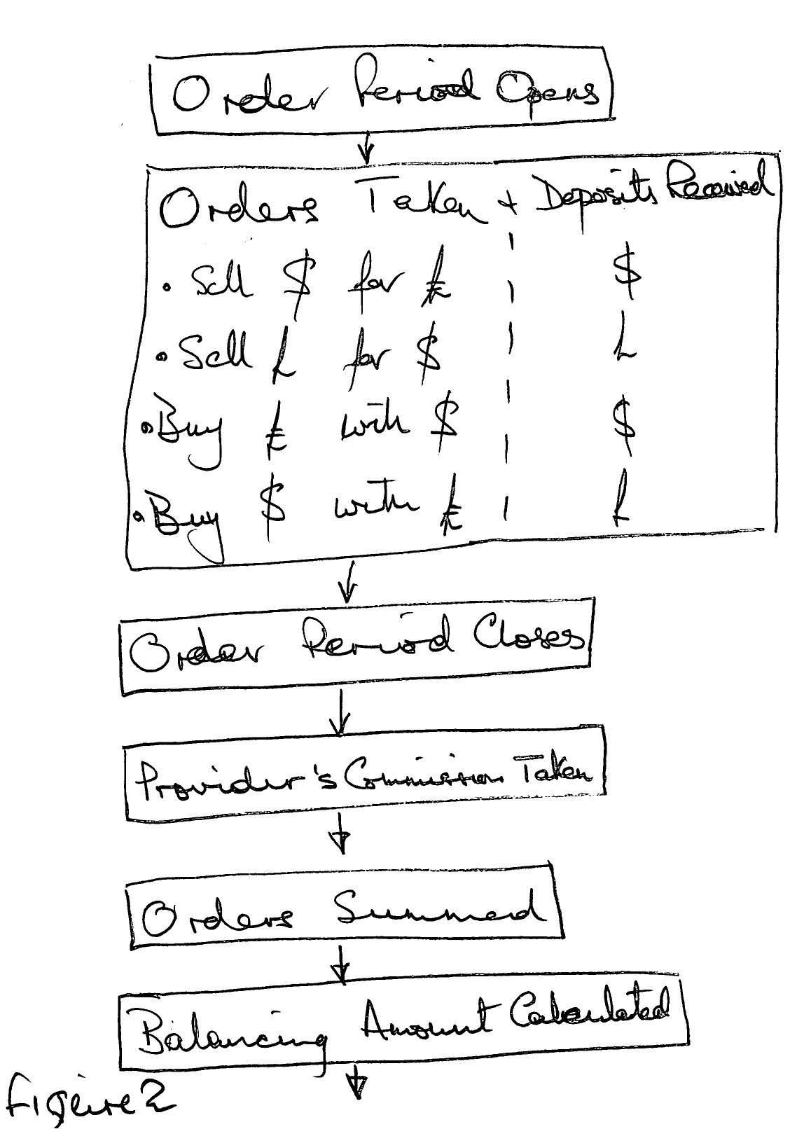

FIG. 1 is a table showing the available and required currency sums corresponding to various orders and corresponding deposits;

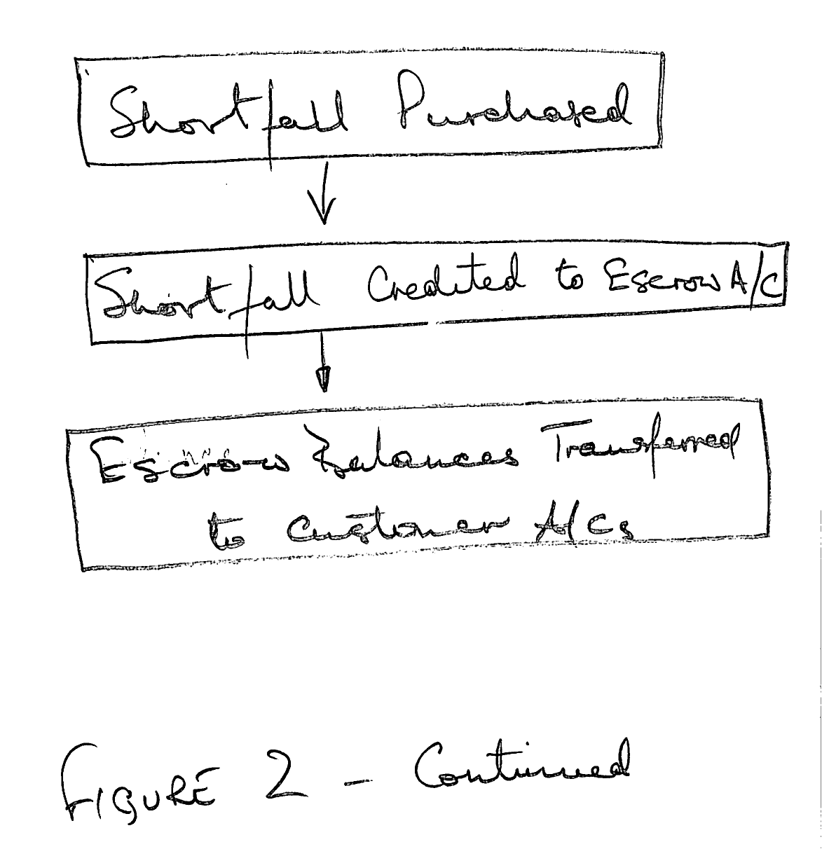

FIG. 2 is a block diagram of a computer system for operating the method of the invention;

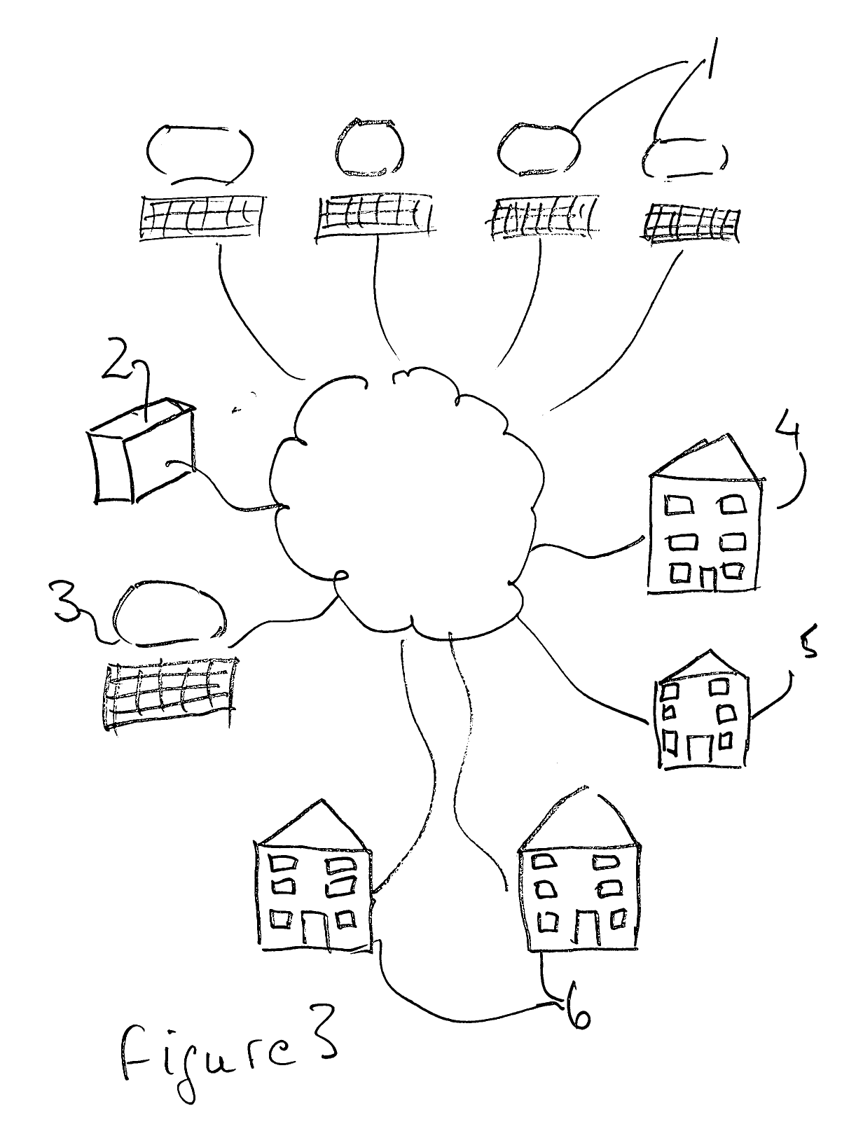

FIG. 3 is a flow chart for a method in accordance with the invention.

A foreign exchange trading business, the ‘provider’, operating the invention typically performs the following steps:
1. The provider establishes a pair of respective currency escrow accounts into which customers can deposit first and second currency amounts to be exchanged. The accounts are established with a third party bank, holding customer funds in escrow;
2. The provider declares that an order period will open at a certain opening time, will close at a certain later closing time and invites orders for two currencies (US$ and £ in this case), from customers wishing to purchase foreign currency with domestic currency and other customers wishing to purchase domestic currency with foreign currency. Typically the currencies will be US $ and UK £ sterling. The provider will quote a provisional exchange rate with the proviso that the actual rate will approximate to the mid-point price at the end of the period, bearing in mind that the actual buy and sell rates of major providers, namely the major banks, change continuously. The mid-point price is mid-way between their buy and sell rates, i.e. their geometric mean;
3. From the opening time in particular, the provider takes deposits over the opening-to-closing order period, which can vary from 24 hours or more to an hour or less. The provider undertakes to return the funds from escrow in event of the deposits not being used, such as in cancellation of an order in the order period. After making their deposits, they make an order in connection with them. The order can be a “sell order” namely to sell the deposited of $ for £ or £ for $ as the case may be. Alternatively the order can be a “buy order” for an exact amount of £ or $, in which case the customer is asked to deposit more than (say, 102% of) the equivalent amount $ or £ taking account of the provisional exchange rate, to allow for movement in the exchange rate. The customers are asked to notify the provider, with their orders, their bank details whither the proceeds of the exchange are to be transferred;
4. At the closing time, the mid-point price is determined by reference to current market conditions for use in converting customers' deposits intended to be converted into the other currency;
5. Also at closing time, in an ideal situation, the provider would have received into the escrow accounts matching amounts in both currencies and could disburse these direct to the respective customers. However, this exactly matching situation is unlikely to occur, added to which the provider needs to charge for the exchange;
6. Accordingly the provider amalgamates all the orders for US dollars and all the orders for pounds sterling and calculates the surplus of one of the currencies, corresponding to which a quantity of the other currency is required to be purchased;
7. Orders to sell deposited currency for its value in the other currency are treated slightly differently from orders to buy a specific amount of the other currency with the requisite amount of the one currency. It is for this that the 102% deposit is required;
8. The amalgamation and calculation of a balancing amount to enable all orders to be satisfied in accordance with the steps set out above is as follows and as shown in FIG. 1:
   8.1 the mid-point prices for conversion of the first currency to the second and vice versa, which rates are the reciprocals of each other, are used to calculate:
      8.1.1 the sum A of the values of the first currency sell orders into second currency and the sum a of the values of the second currency to be exchanged therefrom,
      8.1.2 the sum B of the values of the second currency sell orders into first currency and the sum b of the values of the first currency to be exchanged therefrom;
      8.1.3 the sum C of the values of the first currency required to meet the secondary currency buy orders for specified amounts of the second currency and the sum c of the values of the second currency to be exchanged therefrom,
      8.1.4 the sum D of the values of the second currency required to meet the first currency buy orders for specified amounts of the first currency and the sum d of the values of the first currency to be exchanged therefrom;
   (The sums A & B are known from the sell orders; the sums a & b are derived therefrom via the mid-point price; the sums c & d are known from the buy orders; the sums C & D are derived therefrom via the mid-point price; the sums A & C are deposited in the first currency and the sums B & D are deposited in the second currency; the sums a & c are exchanged second currency; and the sums b & d are exchanged first currency);
   8.2 the surpluses/shortfalls are (A+C)−(b+d) in first currency and (B+D)−(a+c) in second currency and are equivalent to each other, one being a +ve surplus in one currency, the other being a −ve shortfall in the other currency;
   8.3 the surplus of the currency in surplus is sold to allow the exchange to proceed;
9. The balancing amount of the currency in surplus is withdrawn from the relevant escrow account;
10. The sale is made to a foreign exchange providing bank at their prevailing sell rate for the surplus currency in exchange for a corresponding amount in the other currency, which will approximate to the short fall in that currency. This corresponding amount is referred to as the “balancing amount”. There will be one balancing amount only. For instance, where there is an excess of sterling, the requests of customers requiring sterling could be met in full and the requests of the customers requiring dollars cannot be without the balancing amount.
11. An extra small percentage buffer is added to the sale of currency in surplus, whereby purchase of enough of the other currency is assured.
12. Where the result is too much extra currency, in other words there is a residual difference between the part of the buffer actually required to exchange the orders and the acquired buffer, the residual difference is apportioned in proportion to the customers' orders' value to their proceeds in the case of sell orders and to their remaining balances in the case of buy orders. This apportionment will be both to customers' sub-balances in the escrow account in the currency of the balancing amount acquisition and to the other currency escrow account sub-balances. In order to avoid further exchange with the third party, which would be uneconomic, the provider maintains floats of both currencies in each escrow account and credits his sub-balance with that part of the residual balance required to be in the other currency. He then debits his sub-balance in the other currency with an equivalent amount converted at the mid-point price and credits the corresponding customers' sub-balances.
13. There is a commission charge to the provider to be deducted, of say 0.2%. This is deducted, prior to the amalgamating and computing in step 8, from the deposits of currency having sell orders, whereby the amount sold is nett of commission. The commission is also deducted from the buy order deposits prior to conversion and it is allowed for in the request for 2% extra deposit;
14. On receipt of the balancing amount in the currency in shortfall, it is credited to the relevant currency escrow account. The orders are met by debiting the respective escrow accounts and crediting the customers' nominated accounts in the exchanged currencies;
15. On distribution of the converted currency notification is made of the ordered currency having been transferred in accordance with the customers' instructions;
16. Normally a new order period will have opened immediately after the previous one closed and before the summing, matching, balance acquisition and distribution steps for the previous one have been completed.
   These steps are shown in FIG. 2.

It will be apparent that these operations are best performed via software based automated exchange technology.

To describe this in more detail with reference to FIG. 3 of the drawings, a plurality of customers are connected via their work stations 1 and the internet to a provider's server 2. This is connected in turn to provider's work station(s) 3, the provider's deposit taking bank 4 and the provider's foreign exchange providing bank 5. These could be one and the same bank. Additional connections can be between the customers and their banks 6. The latter are connected to the deposit taking bank.

Via an application running on the provider's server, the provider announces that a new order period will start at noon for three hours for example and the expected exchange rate will be for example:

US$1.00 =£0.60

£1.00=US$1.60.

Customers can request dollars for sterling and vice versa. To make an order for one currency, they are requested to deposit first the other currency. For this, customers place orders with their own banks to transfer money to the provider's bank into the respective currency escrow account (established by the provider with its bank for the purpose of holding client segregated funds) designating that the deposit is from the particular customer. Customers then place their orders with the provider. They do this by access to the provider's website, which includes provisions for the orders to be specified to be sell or buy orders. Typically, at this point, customers also notify the provider the details of their bank account to which the converted funds are to be transferred. The method has transcontinental/international application, thus the timings will normally be quoted as Eastern Standard Time. If an order is for an exact amount of the required other currency, i.e. if it is a buy order, the customers are requested to add a margin of say 2% to cover costs and exchange fluctuations. Customers are unable to place orders unless and until they have deposited sufficient funds.

Customers request varying amounts, in both dollars requesting sterling and vice versa. To make a valid buy order for say £6000, $10,000+2% must first have been deposited in cleared funds. The deposit is made with a previously established $ account with the provider's bank 4. That is to say it is an account where the money is held for the customer with the proviso that it can be converted to a different currency and made available to the customer on receipt of instructions (if not already given) to transfer it to his normal bank account on completion of the conversion.

The provider can observe the flow of orders and but has no direct control over them, nor access to the deposited sums during the order period.

On adequate funds having been deposited and receipt of an order, the provider's software application powering the website sends an email to the customer in acknowledgement of the order and stating that it will be processed at the end of the current order period.

At the end of the order period the amounts deposited, the amounts to be sold and the amounts to be bought are known and summed The foreign exchange providing bank is contacted for up-to-date exchange rates both ways, the bank's buy and sell rates. Using these rates the application calculates the mid-point price and using this price calculates in each case the equivalent of these sums to their amounts in the other currency.

There will be a surplus of one currency to be converted. The application converts with this to the other currency, as a balancing amount. For instance, if there is £25,000 surplus, this converts to £25,000×1.60=$40,000.

The balancing amount in the converted currency is paid into the relevant currency escrow account. A further email will be sent when the order has been completed.

The above trading method is both quicker and more efficient than the conventional transaction method and providing customers with total transparency, advantageous exchange rates and reduced costs.

The invention is not intended to be restricted to the details of the above-described operation. The invention will normally be operated in a location where the domestic currency is being exchanged with a foreign currency, for instance in New York with the US $ being exchanged with the pound sterling. It can also be operated in two foreign currencies, for instance in Toronto, again with the US $ being exchanged with the pound sterling—without the exchange involving domestic currency CA $. This can also be the case for multiple currency requirements.

The invention can be extended to three or more currencies, with the relevant steps of the method being triplicated or further replicated as required by the number of currencies.

It should be pointed out that all clients are treated equally and there is no differential pricing or fees based on an individual client volume. A flat percentage fee is charged irrespective of the exchange amount. Nevertheless it can be envisaged that the fee could be discounted for unusually large orders.

Each and every step of the present invention may be accomplished and/or performed by using a computing device or a network of computing devices.

1. A method of currency exchange to be operated by a currency provider, consisting in the steps of:
receiving over an order period from one or more first customers:
deposits in one, first currency (‘the first currency deposits’) and
instructions in respect of the use of at least part of their first currency deposits in the form of:
sell instructions for the sale of a specified amount of first currency in exchange for second currency substantially equal in value or
buy instructions for the purchase of a specified amount of second currency
(‘the second currency sell orders and the second currency buy orders’);
receiving over the order period from one or more of second customers:
deposits in the other, second currency (‘the second currency deposits’) and
instructions in respect of the use of at least part of their second currency deposits in the form of:
sell instructions for the sale of a specified amount of second currency in exchange for first currency substantially equal in value or
buy instructions for the purchase of a specified amount of first currency
(‘the first currency sell orders and the first currency buy orders’); and
performing the following steps on expiry of the order period:
summing the first currency orders;
summing the second currency orders;
comparing the sums of the orders and computing a surplus of one currency and a shortfall of the other;
acquiring from a third party a balancing amount of whichever currency is in shortfall between its deposits and requests from the surplus of the other currency;
distributing the substantially equal value parts of second currency deposits and the purchased shortfall if any to the first customers in accordance with their second currency orders;
distributing the substantially equal value parts of first currency deposits and the purchased shortfall if any to the second customers in accordance with their first currency orders; and
retaining a provider's charge from the deposits.

2. A method of currency exchange according to claim 1, wherein the provider is a bank and the deposits are made into accounts with it.

3. A method of currency exchange according to claim 1, wherein the provider is not a bank and the deposits are made into escrow accounts in the name of the provider with a third party bank.

4. A method of currency exchange according to claim 3, wherein an escrow account for each currency is provided for deposits in the respective currency, with sub-balances within each escrow account being maintained for each customer in the provider's application.

5. A method of currency exchange according to claim 3, wherein the escrow accounts are frozen against a customer's withdrawal from the end of the order period.

6. A method of currency exchange according to claim 3, wherein;
the balancing amount in the acquired currency in shortfall is added to the deposits in the escrow accounts for the same currency,
the acquired currency having been acquired from a surplus in the other currency withdrawn from the other currency escrow account and
the ordered currency amounts are transferred from the escrow accounts to customers' accounts in the respective currencies.

7. A method of currency exchange according to claim 1, wherein the order period is for a published, fixed period.

8. A method of currency exchange according to claim 1, wherein no order is included in the steps on expiry of the order period unless a corresponding deposit has been made in cleared funds.

9. A method of currency exchange according to claim 1, wherein only the part of the deposit substantially equal to that required for the order in question will be taken account of in the steps on expiry of the order period.

10. A method of currency exchange according to claim 1, wherein the acquisition of the balancing amount is via a sell order in the currency in surplus.

11. A method of currency exchange according to claim 1, including publication of provisional exchange rates for the first currency to the second currency and for the second currency to the first currency from the beginning of the order period.

12. A method of currency exchange according to claim 1, including publication of an indication of a marginal amount of additional deposit needed to cover the cost of the exchange in the case of a buy order.

13. A method of currency exchange according to claim 1, wherein the provider's charge is a commission pro rata based on the respective value of the respective order.

14. A method of currency exchange according to claim 1, wherein the provisional rate of exchange is used to convert the deposits in the original currencies to values to be used in calculating the surplus and shortfall, with balancing amount being converted at the prevailing rate offered by the third party.

15. A method of currency exchange according to claim 9, wherein the provisional rate is a mid-point price.

16. A method of currency exchange according to claim 1, wherein a prevailing rate at the end of the order period exchange is used to convert the deposits in the original currencies to values to be used in calculating the surplus and shortfall, with balancing amount being converted at the prevailing rate offered by the third party.

17. A method of currency exchange according to claim 11, wherein the prevailing rate at the end of the order period exchange is a mid-point price.

18. A method of currency exchange according to claim 1, wherein the matching and balance acquisition are performed as follows:
the mid-point prices for conversion of the first currency to the second and vice versa, which rates are the reciprocals of each other, are used to calculate:
the sum A of the values of the first currency sell orders into second currency and the sum a of the values of the second currency to be exchanged therefrom,
the sum B of the values of the second currency sell orders into first currency and the sum b of the values of the first currency to be exchanged therefrom;
the sum C of the values of the first currency required to meet the secondary currency buy orders for specified amounts of the second currency and the sum c of the values of the second currency to be exchanged therefrom,
the sum D of the values of the second currency required to meet the first currency buy orders for specified amounts of the first currency and the sum d of the values of the first currency to be exchanged therefrom;
the surpluses/shortfalls are (A+C)−(b+d) in first currency and (B+D)−(a+c) in second currency and are equivalent to each other, one being a +ve surplus in one currency, the other being a −ve shortfall in the other currency;
the surplus of the currency in surplus is sold to allow the matching to proceed.

19. A method of currency exchange according to claim 1, wherein an extra small buffer is added to the sale of currency in surplus by a sell order, or purchase of currency in deficit by a buy order, whereby an adequate amount of the currency in deficit is assured and any residual difference is distributed between the customers.

20. A method of currency exchange according to claim 19, wherein the residual difference is apportioned to customers' sell orders in respective currencies and customers' remaining balance of buy order deposits in proportion to the values of their orders.

21. A method of currency exchange according to claim 20, wherein:
the deposits are made into escrow accounts in the name of the provider with a third party bank and
where the residual difference is to be apportioned in the other currency from that in which it was acquired, the provider retains that part of the residual difference in its currency as a credit to a provider's sub-balance in the relevant currency escrow account and contributes its equivalent in the other currency by debiting a provider's sub-balance in the other currency escrow account.

22. A method of currency exchange according to claim 1, wherein orders are executed only where sufficient funds have been deposited.

23. A method of currency exchange according to claim 1, wherein the costs of the exchange, including the provider's charge, are debited from the first and second currency deposits.

24. A method of currency exchange according to claim 1, wherein some or all of the distributed first and second currency amounts are exactly ordered amounts of currency specified in respective orders, an additional marginal deposit having been made and from which costs of the exchange, including the provider's charge, have been debited.

25. A method of currency exchange according to claim 1, wherein:
the customers' orders and deposits are received in respect of one or more additional currency and
the steps on expiry of the order period are performed for each additional currency in like manner to those for the first and second currency.

26. A method of currency exchange according to claim 1, wherein a new order period is opened immediately after the previous one is closed and before the summing, matching, balance acquisition and distribution steps for the previous one have been completed.

27. A method according to claim 1, wherein the provider provides a computer application accessible via a website for the customers to place their orders and operable by the provider to execute the remaining steps of the method.

28. A computer system for operating the method of claim 27, including a provider's server adapted to run the provider's computer application and website.
